(19) United States
(12) Patent Application Publication
(10) Pub. No.: US 2008/0035271 A1
(43) Pub. Date: Feb. 14, 2008

(54) METHOD FOR FORMING MICRO BLIND VIA ON A COPPER CLAD LAMINATE SUBSTRATE UTILIZING LASER DRILLING TECHNIQUE

(76) Inventors: Hung-En Hsu, Taipei City (TW); Ming-Chia Li, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/551,252

(22) Filed: Oct. 20, 2006

(30) Foreign Application Priority Data
Aug. 10, 2006 (TW) 095129376

(51) Int. Cl. B32B 38/04

(52) U.S. Cl. 156/272.8; 156/268; 156/280

(57) ABSTRACT

This invention provides a method for forming a micro blind via on a copper clad laminate (CCL) substrate. A CCL substrate having a dielectric layer sandwiched by a first copper layer and a second copper layer is prepared. A laser absorbing layer is formed on the first copper layer. The laser absorbing layer is subjected to laser drilling. A micro blind via is drilled into the first copper layer and the dielectric layer in one step.

### BACKGROUND OF THE INVENTION

1. Field of the Invention

The present invention relates to a process for manufacturing a circuit board and, more particularly, to a method for forming a micro blind via on a one side of a double-side copper clad laminate substrate utilizing laser drilling technique. According to this invention, it is not necessary to form a copper window during the fabrication of the micro blind via.

2. Description of the Prior Art

In recent history, printed circuit boards (PCBs) have been widely used for carrying various electronic components and devices. As there is demand for electronic products to be lighter, smaller, and portable, research and development of printed circuit boards is unavoidably moving toward a direction of miniaturization, higher integration, lower thickness, and the use of multiple layers.

In general, printed circuit boards having circuit layouts on both sides of the circuit boards have been widely used in numerous electrical apparatuses such as air-conditioners, telephones, and fax machines. Nevertheless, it is essential to have a “bridge”, or otherwise referred to as through holes, for communicating between the circuits and electrical wires on both sides of the board. The useable area of a typical double-sided printed circuit board is often twice that of a typical single-sided printed circuit board, and in contrast to a single-sided printed circuit board, the double-sided printed circuit board is more suitable to be used for products with complex circuits.

Please refer to FIGS. 1-5. FIGS. 1-5 are schematic, cross-sectional diagrams illustrating a prior art process of forming a plated micro blind via on a double-side copper clad substrate utilizing laser drilling technique. First, as shown in FIG. 1, a copper clad substrate (CCL) 10 is provided. The CCL 10 comprises an intermediate base layer 12 and copper films 14a and 14b sandwiching about the intermediate base layer 12. The copper film 14a covers the upper side of the CCL 10, while the copper film 14b covers the lower side of the CCL 10.

As shown in FIG. 2, a photoresist layer 16a and a photoresist layer 16b are formed on the copper films 14a and 14b, respectively. A photolithographic process including exposure, development and baking steps is carried out to form an opening 26 in the photoresist layer 16a. Thereafter, using the photoresist layer 16a and the photoresist layer 16b as a hard mask, a copper wet etching process is performed to etch the exposed copper film 14a through the opening 26, thereby forming a copper window 24 in the copper film 14a.

As shown in FIG. 3, a laser drilling process is performed to drill a micro blind via 30 into the intermediate base layer 12 through the copper window 14. The micro blind via 30 exposes a portion of the copper film 14b. Typically, the laser drilling process employs CO2 laser having a wavelength, which the copper film 14b does not absorb. Therefore, the laser drilling process does not etch through the copper film 14b and stops on the copper film 14b.

Subsequently, a conventional de-smear process is performed to remove the residuals on the surface of the CCL 10. After the de-smear process, an electro-less copper plating process is carried out to plate a thin copper layer 32 onto the surface of the CCL 10 and on the interior sidewall of the micro blind via 30.

As shown in FIG. 4, another lithographic process including exposure and development is performed to form a photoresist layer pattern 40a and a photoresist layer pattern 40b on the copper films 14a and 14b, respectively. The photoresist layer pattern 40a and photoresist layer pattern 40b define the circuit layout to be formed on the upper side and lower side of the CCL 10.

As shown in FIG. 5, a plating process is then carried out. Copper wiring patterns 50a and 50b are formed in the area that is not masked by the photoresist layer pattern 40a and photoresist layer pattern 40b. Finally, protective tin layers 52a and 52b is plated on the copper wiring patterns 50a and 50b.

The above-described prior art method has a drawback in that the copper window 24 is required before performing the laser drilling process in order to define the laser burning area in advance. Therefore, it requires one additional exposure/development step and one more copper etching step, thus increases the process time and reduces the throughput. The additional exposure/development step and copper etching step also increases the production cost.

### SUMMARY OF THE INVENTION

It is one object of the present invention to provide an improved method for directly forming a micro blind via on a one side of a double-side copper clad laminate substrate utilizing laser drilling technique without the need of forming a copper window in advance.

According to the claimed invention, a method for directly laser drilling a micro blind via on a copper clad laminate (CCL) substrate is provided. A double-side CCL substrate is prepared. The CCL substrate comprises a first copper film and a second copper film sandwiching about an intermediate base layer. A laser absorbing layer is then formed on the first copper film. A laser drilling process is performed to impinge a laser beam directly onto the laser absorbing layer to burn away a portion of the laser absorbing layer, the first copper film and the intermediate base layer, thereby exposing a portion of the second copper film and forming a micro blind via in the CCL substrate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-5 are schematic, cross-sectional diagrams illustrating a prior art process of forming a plated micro blind via on a double-side copper clad substrate utilizing laser drilling technique.

FIGS. 6-12 are schematic, cross-sectional diagrams illustrating a preferred exemplary process of directly forming a micro blind via on a double-side copper clad substrate utilizing laser drilling technique in accordance with one preferred embodiment of this invention.

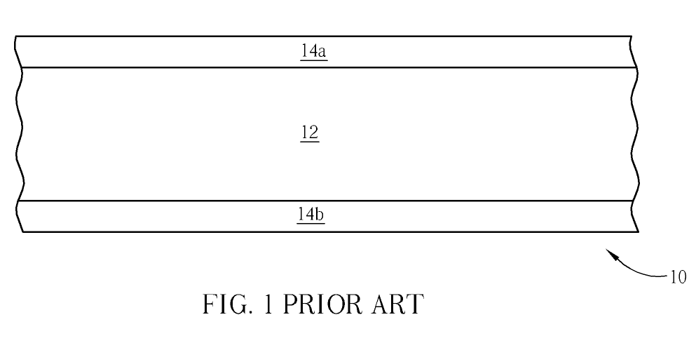

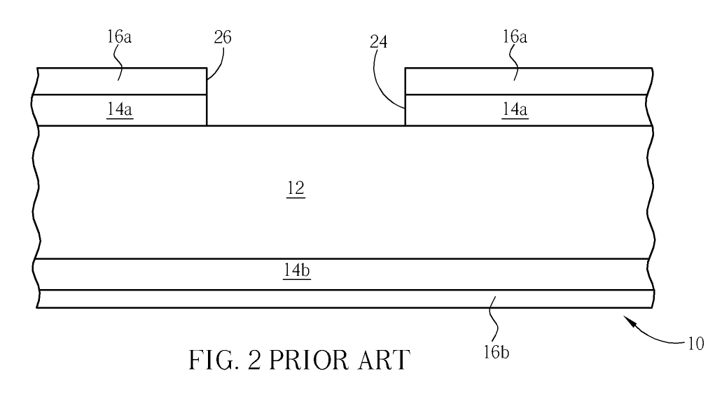

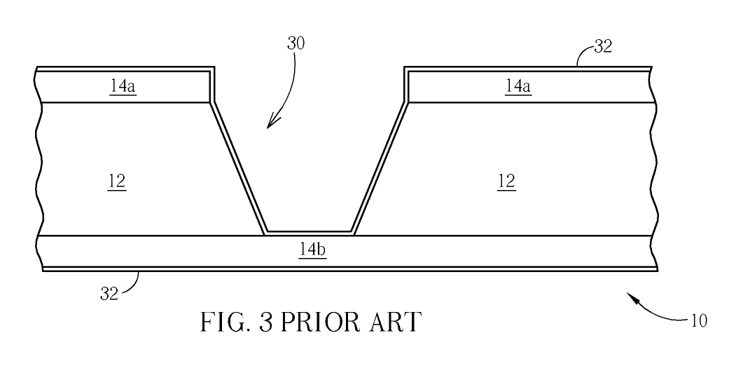

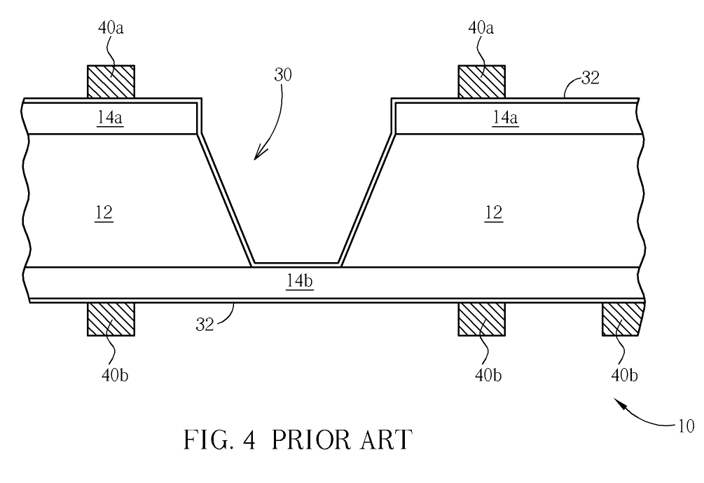

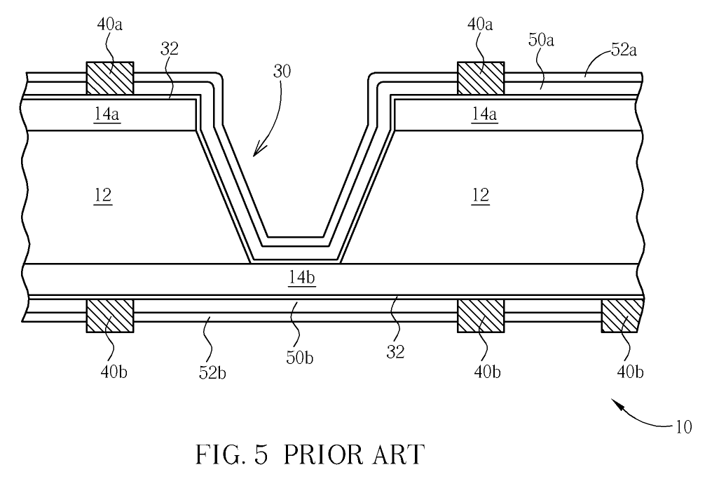

### DETAILED DESCRIPTION

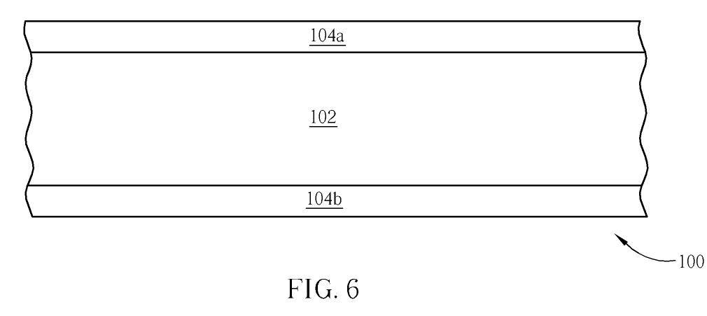

Please refer to FIGS. 6-12. FIGS. 6-12 are schematic, cross-sectional diagrams illustrating a preferred exemplary process of directly forming a micro blind via on a double-side copper clad substrate utilizing laser drilling technique in accordance with one preferred embodiment of this invention. As shown in FIG. 6, a double-side copper clad laminate (CCL) substrate 100 is provided. The CCL substrate 100 comprises an intermediate base layer 102 and copper films 104a and 104b sandwiching about the intermediate base layer 102. The intermediate base layer 102 may be made of prepreg or any other suitable dielectric insulating materials.

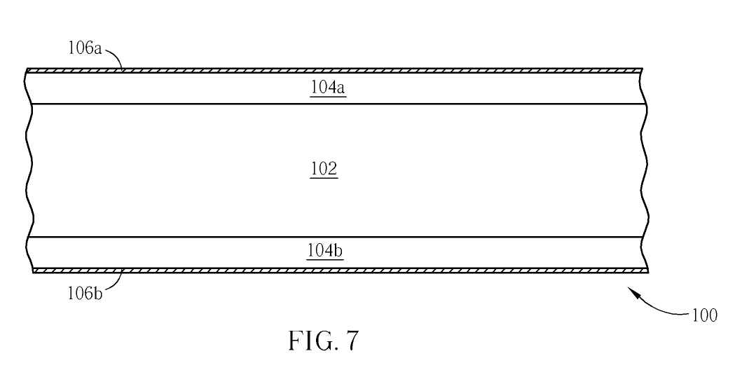

As shown in FIG. 7, a laser absorbing layer 106a and laser absorbing layer 106b are formed on the copper films 104a and 104b, respectively. The laser absorbing layer 106a and laser absorbing layer 106b is capable of absorbing a laser radiation with a pre-determined laser wavelength. According to the preferred embodiment of this invention, the laser absorbing layer 106a and laser absorbing layer 106b is comprised of copper oxide. The method for forming the laser absorbing layer 106a and laser absorbing layer 106b may include the step of contacting the copper films 104a and 104b with solution containing NaClO/NaOH. However, other materials that are capable of absorbing laser radiation may be used. This invention should not be limited to copper oxide and it formation method. Preferably, the laser absorbing layer 106a has a thickness of about 0.5-1.5 micrometers.

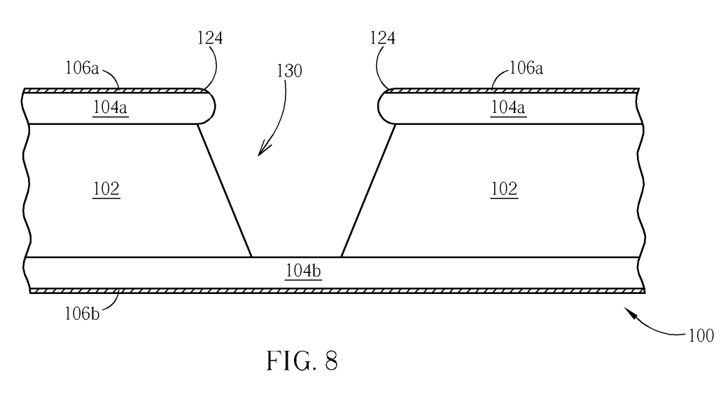

As shown in FIG. 8, after the formation of the laser absorbing layer 106a and laser absorbing layer 106b, a laser drilling process is carried out. The laser beam directly impinges on the laser absorbing layer 106a, and etches the laser absorbing layer 106a, the copper film 104a and the intermediate layer 102, thereby forming a micro blind via 130. According to the preferred embodiment, the laser is CO2 laser. The laser absorbing layer 106a is capable of absorbing the wavelength of the CO2 laser and has a laser absorbility of 50% or higher. The laser drilling process stops on the copper film 104b.

It is one distinct feature of the present invention that the copper window is not required before the laser drilling process. The laser directly impinges on the laser absorbing layer 106a, which absorbs the laser energy in a very short period of time and concurrently releases heat to burn away and vaporizes the underlying copper film 104a and the intermediate base layer 102 around the area on which the laser beam impinges. A photo mask for defining the copper window is thus omitted. The method provided according to this invention is therefore much simpler and more cost-effective.

Furthermore, other metal layers or material films that are capable of absorbing the laser radiation as described above may be used to cover the laser absorbing layer 106a.

It is another distinct feature of the present invention that overhang structure 124 is formed around the rim of the micro blind via 130 as specifically indicated in FIG. 8.

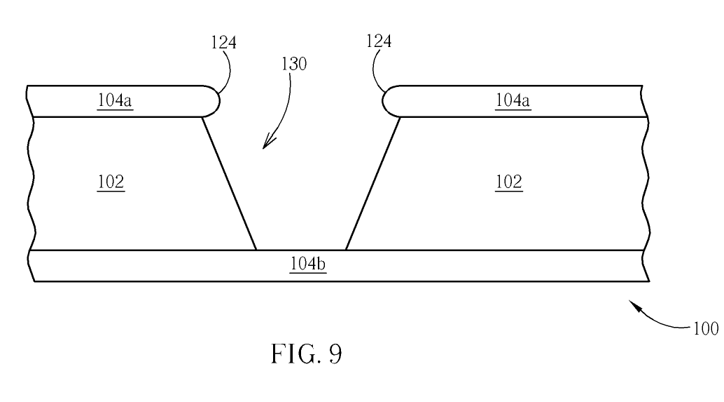

As shown in FIG. 9, after the laser drilling process, the remaining laser absorbing layers 106a and 106b are removed to expose the copper films 104a and 104b.

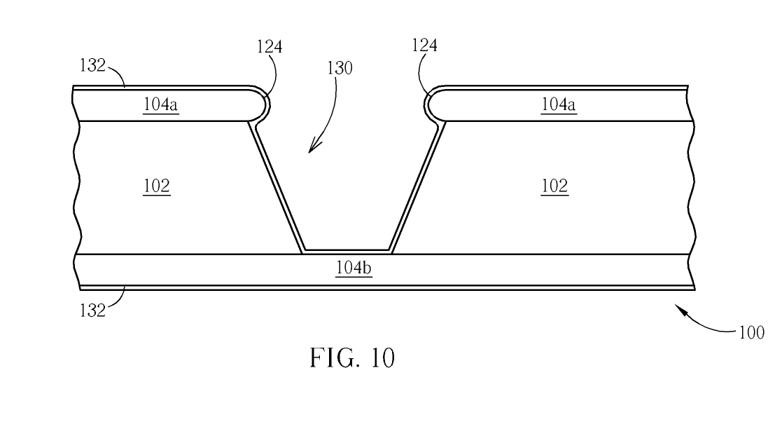

As shown in FIG. 10, a conventional de-smear process is carried out to remove the residuals on the surface of the CCL substrate 100. The residuals may be sputtered substances during the laser drilling. After the de-smear process, an electro-less copper plating process is carried out to plate a thin copper layer 132 onto the surface of the CCL substrate 100 and on the interior sidewall of the micro blind via 130.

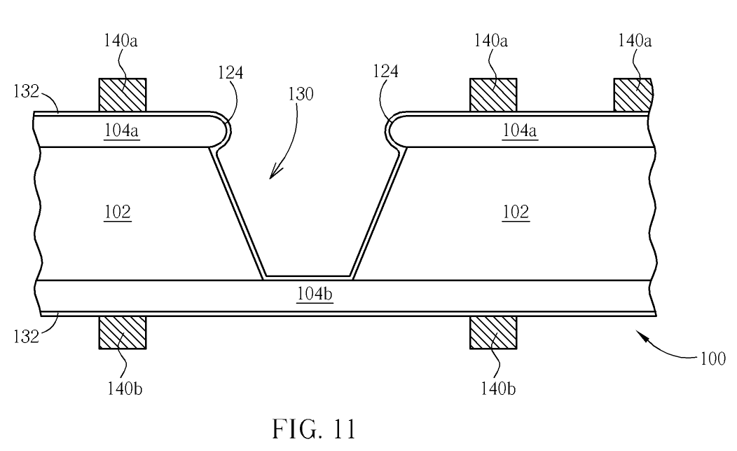

As shown in FIG. 11, a lithographic process including exposure and development is performed to form a photoresist layer pattern 140a and a photoresist layer pattern 140b on the copper films 104a and 104b, respectively. The photoresist layer pattern 140a and photoresist layer pattern 140b define the circuit layout to be formed on the upper side and lower side of the CCL substrate 100.

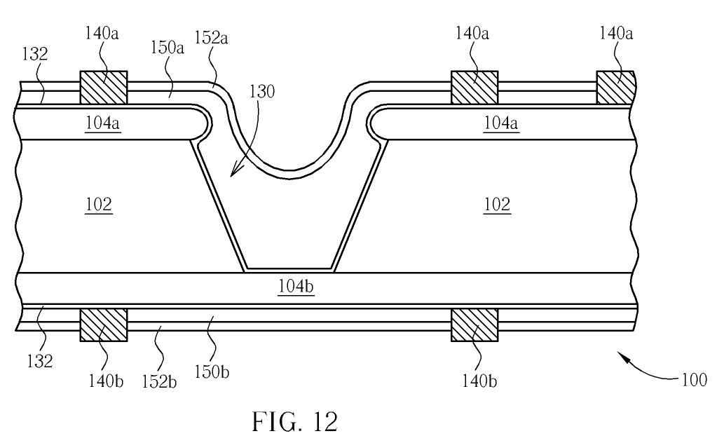

As shown in FIG. 12, a plating process is then carried out. Copper wiring patterns 150a and 150b are formed in the area that is not masked by the photoresist layer pattern 140a and photoresist layer pattern 140b. According to this preferred embodiment, the micro blind via 130 is not completely filled with plated copper 150a. Preferably, ⅓ of the depth of the micro blind via 130 is covered with the copper. In another case, the micro blind via 130 is completely filled with plated copper.

Finally, protective tin layers 152a and 152b is plated on the copper wiring patterns 150a and 150b.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for directly laser drilling a micro blind via on a copper clad laminate (CCL) substrate, comprising:
providing a double-side CCL substrate comprising a first copper film and a second copper film sandwiching about an intermediate base layer;
forming a laser absorbing layer on said first copper film; and
impinging a laser beam directly onto said laser absorbing layer to burn away a portion of said laser absorbing layer, said first copper film and said intermediate base layer, thereby exposing a portion of said second copper film and forming a micro blind via in said CCL substrate.

2. The method of claim 1 wherein said laser beam is generated by a CO2 laser.

3. The method of claim 1 wherein said laser absorbing layer comprises copper oxide.

4. The method of claim 1 wherein said laser absorbing layer is formed by contacting said first copper film with solution containing NaClO/NaOH.

5. The method of claim 1 wherein said laser absorbing layer has a laser absorbility of about 50% or higher.

6. The method of claim 1 wherein said laser absorbing layer has a thickness of about 0.5-1.5 micrometers.

7. The method of claim 1 wherein said intermediate base layer comprises dielectric materials.

8. The method of claim 7 wherein said dielectric materials comprise prepreg material.

9. The method of claim 1 wherein an overhang structure is formed around a rim of said micro blind via.

10. The method of claim 1 wherein after forming said micro blind via, the method further comprises the following steps:
removing said laser absorbing layer;
forming a thin copper layer on said first, second copper films and on interior sidewall of said micro blind via;
forming a first and second photoresist patterns on said first and said second copper films respectively to define wiring layout to be formed on said first and said second copper films; and
performing a plating process to deposit copper wiring on area that is not masked by said first and second photoresist patterns.
